(19) United States
(12) Patent Application Publication
(10) Pub. No.: US 2005/0009525 A1
(43) Pub. Date: Jan. 13, 2005

(54) Wireless phone with interface to different networks

(76) Inventor: Tom Evslin, Princeton, NJ (US)

Correspondence Address: KAPLAN & GILMAN , L.L.P., 900 ROUTE 9 NORTH, WOODBRIDGE, NJ, 07095, US

(21) Appl. No.: 10/614,138

(22) Filed: Jul. 7, 2003

(51) Int. Cl. H04Q 7/20

(52) U.S. Cl. 455/445

(57) ABSTRACT

A communications system and device in which wireless data devices designed for communications over a packet switching network such as the Internet, and wireless telephony devices designed for communications over a telephone network, may roam among various networks of each type of technology. If a wireless telephony device roams to an area covered by the packet switching network, it converts protocols to operate as a data device. If a wireless data device roams to a telephony network, it also changes mode. Means are provided to inform the home network of the wireless data device or cell phone that the device or cell phone has roamed onto a different type of network.

### TECHNICAL FIELD

This invention relates to telecommunications, and more specifically, to an improved wireless communications device capable of interfacing to digital data networks and analog or digital wireless telephony networks such as CDMA, TDMA, GSM, and other types of such wireless telephony networks. The invention also relates to a technique of automatically roaming between the two types of networks and other communications networks as well. A networking system in which the inventive device may be utilized is also disclosed.

### BACKGROUND OF THE INVENTION

Wireless communication devices have become prevalent over the past several years, with most individuals utilizing one or more such devices such as cell phones, wireless e-mail devices, etc. Most such devices are capable of access over a wide geographic area that can often include either an entire continent, or even most of the world. Utilizing a cell phone as the illustrative example, the communications systems require that the phone be located and tracked on a variety of wireless telephony networks that are foreign to the cell phone's “home network”.

The home network is a network or small portion thereof associated with the carrier that provides the service to the cell phone, and is usually limited geographically or by other means. For purposes of explanation herein, we define a “roaming network” as a network covering an area where the cell phone or other device is located when it is not located on its home network. For example, if a cell phone is serviced by Verizon, it may be on its home network whenever it is within the portion of the Verizon network that is within the northeastern United States. However, when the cell phone is located in Mexico, and it must connect to the network via a Mexican cellular network, it is said to be roaming, or on a roaming network; i.e.; a network other than the basic northeastern United States coverage area. Additionally, if the cell phone is used in Seattle, it is also said to be roaming because it is not directly connected to the “home network”, the portion of the Verizon network covering the northeastern United States. Instead, it may be connected to a different portion of the Verizon network. The foregoing two types of roaming are termed on network roaming (e.g.; Seattle, where the user can connect to the Verizon network, but not to the portion that includes his normal coverage area) and off network roaming (e.g.; in Mexico). The present invention is applicable to both types of roaming, although we use off network roaming for exemplary purposes only herein.

Additionally, the user may be roaming even when he or she is physically within the purview of the home network. For example, the user may be connected via a roaming network because the home network is experiencing congestion or other problems, or because an alternative network is simultaneously available and is preferred for any of a variety of reasons. In the present specification, “roaming” is intended to cover any situation wherein the user is not directly connected to the home portion of the network, regardless of the reason why, and regardless of whether the cell phone is physically capable of connecting to that home network based upon its location.

Typically, an out of band signaling mechanism is used to allow communications with the cell phone when it is roaming. For example, the well-known SS7 out of band signaling protocol can be used by other networks to advise the home network that the cell phone is located within the service area of a roaming network. For example, consider a cell phone whose home network is a New York based wireless carrier. When the user of that cell phone travels to Mexico and uses the cell phone, the phone can still receive calls. This is accomplished because the cellular network in Mexico detects the presence of the cell phone and recognizes that the cell phone's home network is a New York based cellular network. The Mexican wireless cell network then uses out of band signaling, such as SS7, to advise switches in the New York based home network that the cell phone is presently located in Mexico. Calls that arrive for that cell phone at the home network are then forwarded via the public switched telephone network, to the Mexican cellular network, for completion to the subject cell phone.

Although the foregoing system is acceptable in most cases, it fails to utilize existing technology with respect to IP networks, such as wide area packet switching networks, including, but not limited to, the Internet, to maximize efficiency. More specifically, the foregoing prior art systems provide little or no mechanism for maximizing usage of packet switching in the Internet and other IP networks, and no technique of taking advantage of the resulting reduced costs and/or expanded coverage areas where there may be Internet access but no cellular coverage.

Presently, there exist Internet Protocol (IP) wireless devices, which communicate over packet switched data networks using a wireless mode. These devices may also roam to various other networks and service providers. However, unlike the case of cell phones, there is no technique for easily merging the widespread deployment of cellular networks typically utilized for telephones with the packet switching data networks utilized for wireless IP devices. Consequently, existing networks and systems fail to take advantage of the ability to merge the advantages of many different types of networks and devices.

Travelers with IP devices are also often able to log on to the Internet through wired connections to local area networks in homes and offices they are visiting, in hotel rooms, and in their own homes. Currently, they have no way to take advantage of these connections using their cellular voice phones.

In view of the foregoing, there exists a need in the art for combining the use of both wireless cellular networks previously intended for telephony applications and wireless IP networks previously intended for use with wireless IP devices but not specifically designed for voice service to give wider coverage for voice and other applications. There also exists a need to allow cell phones to connect though wired Internet connections.

### SUMMARY OF THE INVENTION

The above and other problems of the prior art are overcome in accordance with the present invention. The inventive method and apparatus comprises a telephony device that can interface to an IP network. Instances of the device may connect to an IP network with a wireless protocol such as 802.11 or a wired connection such as Ethernet or both. The device can also interface to a typical cellular telephone network either on its own or through the attached cell phone. Depending upon location and configuration programmed by a user, the device may automatically select, or be configured to select, the appropriate network, whether an IP or cellular network. The device uses the connector built into most cell phones and may be manufactured in variations to fit each model of cell phone. The device may provide power to the cell phone.

In an enhanced embodiment, the device may automatically utilize either type of network, and may either automatically or manually be configured to utilize the addressing system employed by any of the networks. Means are provided within the network for converting addresses between those utilized by each of one or more networks. Accordingly, the cell phone attached to the device may indirectly through the agency of the device use any of one or more different addressing systems, and conversion among the addressing systems may occur in one or the other network if necessary.

### BRIEF DESCRIPTION OF THE DRAWINGS

FIG. 1 depicts a conceptual diagram of a cell phone of the present invention as used in a network system;

FIG. 2 depicts an alternative embodiment of the present invention;

### DETAILED DESCRIPTION OF THE PREFERRED EMBODIMENT

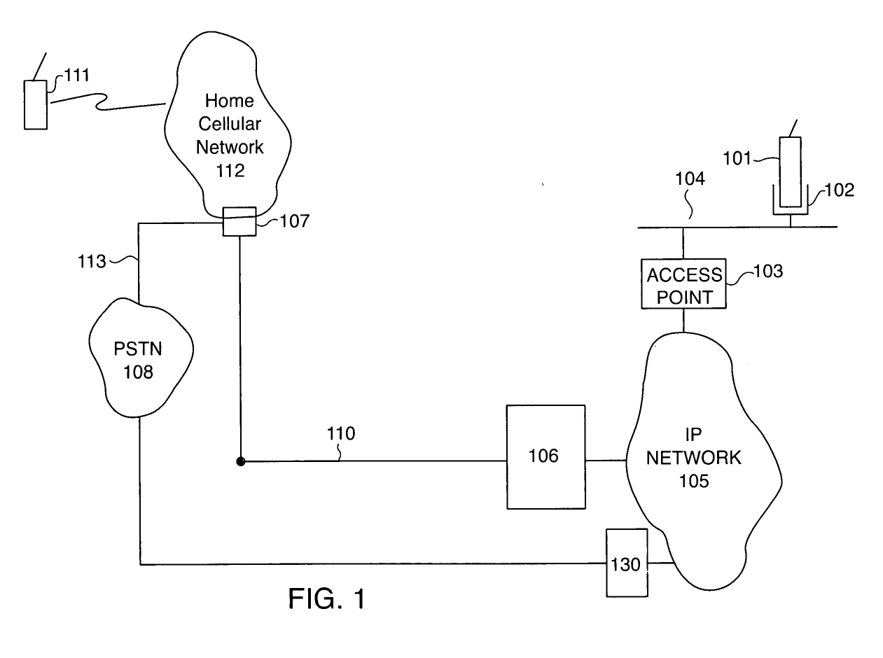

FIG. 1 depicts a block diagram of a system utilizing the teachings of the present invention. The arrangement of FIG. 1 shows only small portions of the Public Switched Telephone Network (PSTN) and the Internet or other IP network 105. It is understood however, that these portions of the PSTN 108 and IP network 105 are part of a much larger system of networks that span wide geographical areas.

FIG. 1 includes a cell phone or similar device 101 and adaptor 102 to be further explained hereafter. A local area network, which may be wireless or hardwired, is represented by 104, and serves to connect the adaptor 102 to an IP network access device 103.

A server 106 interfaces with an out-of-band signaling network such as 110 which uses SS7 or some other telephony signaling protocol and an IP network 105 as shown. The cellular network 112 is connected to various phones such as 111, and switching devices such as 107. An additional server 130 is also shown which is connected to IP network 105 and the PSTN 108.

Adapter 102 is a relatively small device into which a cell phone 101 can be inserted. The adapter 102 contains a network interface to communicate over a Local Area Network (LAN) 104. LAN 104 may itself be wireless, such as the WiFi type of network, or may represent any other type of LAN or other IP network. Adapter 102 serves to convert the typical cell phone protocol into the appropriate networking protocol utilized by network 104 and vice versa. It is also noted that while the adaptor 102 is shown as separate from the cell phone 101, it is also possible to build the adapter and cell phone as one unit, so that the cell phone is capable of operating in plural modes, one of which includes a direct connection to an IP network.

In operation of the exemplary embodiment of FIG. 1, when a user of cell phone 101 roams to an area covered by an IP interface, rather than, or in addition to, a cell network, the cell phone 101 may be converted for use as an IP phone and is still reachable at its assigned phone number and may make outgoing calls billed to its cellular account It is assumed for this example that the home network of cell phone 101 is cellular network 112. The adapter 102 identifies the nearest access device 103 with which to communicate, and the network 104 over which such communications may take place. The identification of the interfacing network 104 may then occur automatically, as in adapter 102 detecting the carrier signal of the specified type, or may be done manually by the user configuring via switches or other means to set adaptor 102 to an appropriate network 104.

The use of automatic selection of an appropriate interface can also prioritize various network interfaces in the event that plural such networks are available. For example, if a user is within range of a WiFi transceiver as well as a typical cell phone network transceiver, the user may set priorities as to which one would be selected first. Thus, the adapter 102 can be programmed to check first for WiFi, if it is available use it, and if not, check for an Ethernet, if not, check for a cell phone interface, etc. Additionally, rather than a fixed set of priorities being established, the user may establish rules and logic to allow the device to select the most efficient network. For example, signal strength, cost differences, whether the call is inbound or outbound, or other criteria may be accounted for in the network selection. In any event, adaptor 104 eventually determines that it is interfacing to an Ethernet, for example. After the appropriate network selection is made, communications are established between adaptor 102 and server 106 thru access point 103 and IP network 105

Adaptor 102 signals to cell phone 101 that a signal has been detected from a “tower” (actually Server 106 in the case where an IP network has been chosen) and cell phone 101 than transmits its identity to adaptor 102. Adaptor 102 translates the cell phone protocol identity sequence to IP packets and sends them to server 106. Server 106 recognizes that cell phone 101 is roaming from its home network from the identity information that has been sent.

Notably, the “roaming” may take place even when the cell phone and its user are physically located within the home coverage area of the cell phone user so long as the cell phone is also located within the coverage of a WiFi receiver or other IP access point, and the cell phone 101 has been configured to select the IP network with which to communicate, rather than the cellular telephony home network. This situation is also intended to be included in the definition of “roaming” because the cell phone is not obtaining network access through the usual portion of the cellular telephony network associated with the cell phone as its home network.

Continuing with the description of FIG. 1, the information conveyed by cell phone 101 to server 106 is sufficient for server 106 to identify the home network of cell phone 101. Such information may include an identification of the actual home network of cell phone 101, of a specific server or switch on the home network 112, and/or other identifying information to assist the server 106 in establishing communications with the home network of cell phone 101.

Server 106 may then communicate to a switch and/or server 107 in the home network 112. After server 106 detects the relevant information from cell phone 101, it transmits messages through server/switch 107, informing server/switch 107 that cell phone 101 is presently communicatively coupled to IP network 105 rather than to its home network 112. This information can flow from server 106 to server 107 via a plurality of mechanisms. For example, SS7 signaling, an out of band signaling protocol typically used for call setup in conventional telephone networks, can be used. This information may also flow using any other out of band protocol, IP connections using public and/or private data connections such as the Internet, the PSTN, or any of a variety of other techniques. Further, this information may, but does not need to, include other information indicating that the network 105 is an IP network.

In one or more embodiments, the SS7 signaling is used between the IP network 105 and home network 112 may be identical to existing SS7 signaling, resulting in cellular networks being able to advantageously utilize the invention even if they only implement standard, prior art SS7 signaling. In other embodiments, more advanced signaling conveying other billing and identification/authentication information may be used. For example, 110 may represent an IP connection, over which server 106 transmits the appropriate authentication/identification information, billing information, etc. The communications line 110 is not intended to imply or be limited to any type of connection, and both the media and protocol utilized thereon may vary.

Regardless of the signaling used, switch/server 107 is eventually given a new phone number representing an entry point into IP network 105 servicing the cell phone 101. In the example of FIG. 1, switch/server 107 could be given a telephone number representing server 130. Preferably, server 130 is deployed such that only a local call over PSTN 108 is required to connect switch/server 107 to server 130. When the incoming call arrives at network 112, it will then be conveyed through server 107 and PSTN 108 to server 130. Upon receipt of the call, server 130 would then utilize IP signaling via IP network 105 to contact server 106 for further instructions. In this embodiment, server 106 is acting as a “gatekeeper” as that term is used in standard protocols such as H.323. Server 106 would then convey to server 130 the IP address of adaptor 102, so that server 130 would then have all of the information it needs to convey the call through access point 103 and adaptor 102 to the cell phone 101. Alternatively, the address of adaptor 102 can be conveyed to server 130 in advance of the call arriving, although a mechanism for keeping such data current, such as periodic updates or updates whenever routing information changes, would have to be provided.

In any case, after switch/server 107 is advised of the number at which to contact an IP network 105 presently servicing the cell phone 101, calls arriving from caller 111 to home network 112 destined for cell phone 101 would be rerouted through server 107 to server 130. As shown in the example of FIG. 1, such rerouting may be accomplished in one example by transmitting the call over a line 113 to PSTN 108 for conveyance to server 130. In another embodiment, servers 130 and 106 may be a single physical server.

It is noted that since either or both of switch/server 107 and servers 106 and 130 may be configured to communicate with various combinations of IP networks and telephone networks, plural techniques for routing the incoming call from home network 112 to IP network 105 may be utilized. Indeed, both the control and media associated with the call can be exchanged between the networks 112 and 105 using various combinations of in band and out of band signaling, IP and telephony signaling, and one or more intermediate gateways and switches

It is also noted that the addressing system utilized by cell phone 101 and implemented in the embodiment shown in FIG. 1 may be its normal telephone number and/or other cellular identifying information. Adaptor 102 is identified on IP network 105 by an IP address. Server 106 performs the mapping between the IP address of adaptor 102 and the identifying information of cell phone 101. Moreover, server 106 assigns an inbound telephone number associated with server 130 (or other server) on the PSTN and associates this with cell phone 101 and adaptor 102 for as long as they are roaming on IP network 105. The IP address of adaptor 102 may be dynamically assigned by any component in the network, such as, for example, access server 103. When a call is received by server 130 or some other server for the phone number associated with cell phone 101, either the servers 106 or 130, or some other device, translates that telephone number into the network address on network 104 at which the cell phone 101 can be found through adaptor 102.

In operation, a call arriving from telephone 111 and directed to cell phone 101 is received in cellular network 112. Cellular network 112 forwards the call to server/switch 107 for forwarding to a sever designated by server 106 (e.g. 130) via links 113 and PSTN 108. The call is then completed via IP network 105, over the data network 104, through the access point 103, through adaptor 102, and ultimately to the cell phone 101. In the aforementioned process, server 106 provides the information to convert the dialed telephone number into an IP address on IP network 105. Such conversion is sufficient to route the call through IP network 105 to adaptor 102. Access point 103 is connected to network 104 and thus has the appropriate addressing information to complete the call to adaptor 102.

While the foregoing describes call flow in the case of an incoming call, the message and control flow for an outgoing call initiated by cell phone 101 is different. Referring still to FIG. 1, in the case of outgoing calls, authorization information is requested from home network 112 either when the cell phone 101 first appears on the IP network 105 or when the call is being attempted. Such authorization may be requested by communicating with home network 112 using any of the previously described techniques.

If the call is authorized, it may be completed through server 130 or some other server designated by server 106 to the PSTN 108 in the normal manner and billing information may be transmitted back to home network 112 by SS7 signaling or in any other convenient manner. In the special case where the called number is also presently within the called purview of server 106, or the purview of another IP network to which server 106 may connect, the call may be completed using IP all the way without ever utilizing the PSTN for the media and/or control stream

It is also noted that while the home network has been described as a cellular telephony network and the IP network is the roaming network, the invention is not so limited. An IP network may be utilized as the home network, and the cell phone 101 may be deemed roaming when it is on a cellular telephone network, or potentially other IP network. In this case, using present day protocols, the cellular network sends an ss7 message to the home IP network (which looks to it like another cellular network). The media server 130 associated with 106 owns the phone number of the called phone as far as the PSTN network is concerned. Whenever the server 130 receives a call (including cases above) it asks server 106 what to do with it. Server 106 will instruct it to forward the call via IP or PSTN as appropriate to the network onto which the user has roamed, which may be some other IP network, or the PSTN.

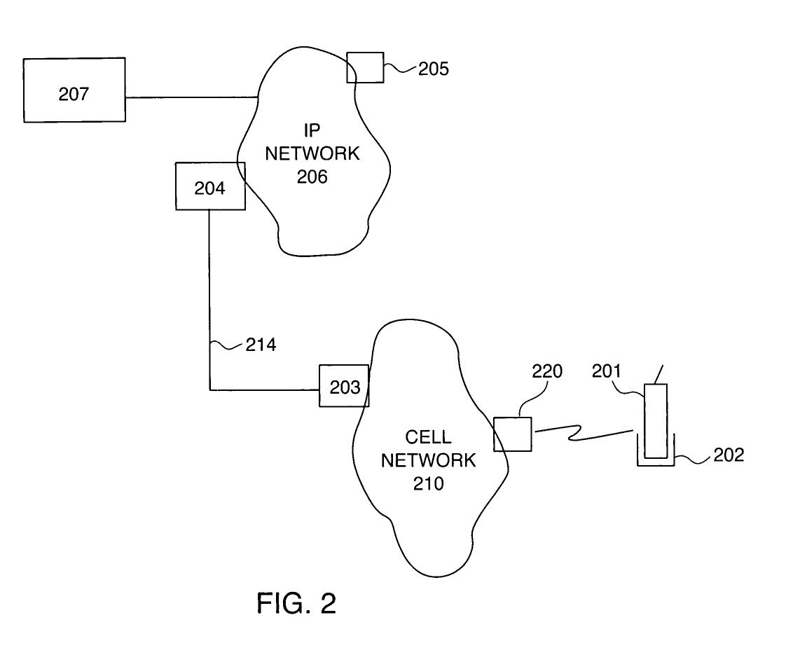

FIG. 2 depicts an alternative embodiment of the present invention in which an IP phone 201 is connected to an adapter 202. The adapter 202 is configurable to communicate to a standard cellular network 210, shown in FIG. 2, with two exemplary cells/switches 220 and 203 within that network. The switch 203 is connected via a communications channel 214 to a server 204. As shown, the server 204 is connected to a packet switching network 206 such as the Internet.

In operation, IP phone 201 may sometimes be located in an area covered by a conventional cellular network 210 and not connected directly to IP network 206. An adapter 202, which may also be built into the IP phone 201, is utilized to implement the connection between one of the cells 220 on cellular network 210, and the IP phone 201.

In operation, the IP phone may operate utilizing a conventional cellular telephone network in a manner that is the converse of that previously described with respect to cell phone 101. More specifically, when the adapter 202 converts IP phone 201 into a type of phone that may be utilized on cellular network 210, information identifying the cell phone 201 and its temporary phone number on cellular network 210 is transmitted from the cellular network 210 to a server 204 in the IP network 206 via communication line 214. The communication over line 214 may also be implemented as out of band signaling such as SS7, IP signaling, or any other type of signaling. Notably, by using SS7 or other standardized signaling, the wireless telephony network need not be altered from its present day operation.

Once a server 204 is notified that the IP phone 201 is actually roaming on a cell network 210, voice and data arriving for the IP phone at IP network 206 are rerouted to the cell network 210 for forwarding to the IP phone 201 over the cell network 210 through adapter 202.

As explained with reference to FIG. 1, the IP phone 201 may be addressed by utilizing a telephone number in the cell network 210, or an IP address. Alternatively, the addressing scheme and interface may be selected as previously described, either automatically or manually. As explained in the previous embodiment, outgoing calls may be first authenticated and validated via signaling between the home network 206 and the cell network 210 for billing purposes, prior to permitting the outgoing call.

When voice/data travels over the conventional cellular telephony networks, protocols for conventional cellular telephony are used, such as CDMA and other well-known protocols. When voice/data travel over packet switched data networks, the packet switching protocols such as TCP/IP and other well-known protocols are used. In the case of a single device that can act as a cell phone and IP data device or IP phone, the embodiments of FIGS. 1 and 2 may be implemented for the same device, depending upon which network is accessed and designated as the home network, and which mode in which the device is operated.

It is understood that the forgoing describes preferred embodiments of the invention, but that various modifications and additions will be apparent to those of skill in the art.

It is also possible that the same phone may act as a cellular phone to provide identifying information to the cellular network and to implement billing, but calls are actually routed to and from an IP network using an IP capability or adaptor with the phone. This, too, can be reversed so that the IP phone communicates billing and authentication information to the IP network, but calls may actually be placed over the cell network from a cell phone, which is potentially the same IP phone in a different mode.

The out of band signaling between the IP network and wireless cell network may also be used to convey data. Instant messaging, for example, utilizes SS7 signaling to convey meaningful data. When a user of cell phone 101 desires to send an instant message (“IM”), the IM is converted to IP by adapter 102 and transmitted to server 106. Server 106 converts the IM to SS7 signaling, and transmits the IM over an SS7 network to switch/server 107. Switch/server 107 may then forward the IM to the cell phone to which it is addressed, either directly or using other SS7 networks, or potentially unrelated networks. Switch/server 107, being related to the home cellular network of cell phone 101, may also be responsible for logging appropriate billing information so that the user gets properly billed for the transmission. It is also possible that the user to which the IM is directed is also within the purview of IP network 105, in which case the IM may go from server 106 directly to an access point or gateway on IP network 105, for forwarding to a destination user.

For an inbound IM utilizing SS7 messaging, assuming the source of the IM is not on IP network 105, such message arrives at server 106 via an SS7 network. The network originally directed the message to home cellular network 112, after which the IM was directed to server 106 based upon the techniques previously described herein. Upon arrival at server 106, the SS7 message may be converted to IP and forwarded to adapter 102 via IP network 105. Upon arrival at adapter 102, conversion from IP to cellular protocol is accomplished, and the message forwarded through to cell phone 101.

In other embodiments of the invention, any SS7 signaling may be sent via IP between the IP and wireless telephony networks, and out of band signaling may be used to convey a variety of different types of information that may be meaningful to a user, such as instant messaging.

It is also noted that the adapter could be a full PC, whereby call are routed to the address of the PC. Upon recognition by the PC that the incoming data is actually a telephone call, the PC may route the incoming call over a dedicated or other wireless or wired link to a phone, either a normal PSTN phone or a wireless phone. It is also possible to equip the adaptor with a normal PSTN interface, so it can translate between the cell phone protocol and the PSTN protocol. In still another variant of the adapter, the adapter may interface to the cellular network or the PSTN and also have the same functionality of a typical cordless phone, allowing RF communications between a handheld device and the adapter. In this case, the adapter functions as a base station and the handheld device may roam. Software within the adapter receives and transmits PSTN signals, from and to the PSTN, respectively, in accordance with normal telephone protocols, and translates such signals to cellular protocols. The cellular protocols are used to and from the wireless device, possibly over a wireless connection. The PSTN protocols may be used between the adapter and the PSTN, in the normal fashion utilized by a cordless phone base station of the present art. Thus, the adapter may interface between the cell phone and either an IP network, a cell network, a PSTN network or other network. Selection among any one or more such networks can be accomplished as described previously herein.

The foregoing is intended to describe only the preferred embodiments of the invention. Various other modifications and additions will be apparent to those of skill in the art, and are intended to be covered by the claims appended hereto.

1. A method of utilizing a communications apparatus designed for use with one or more cellular telephone networks, the method comprising:
Converting an address utilized by said cellular telephone network to an address utilized by a data network;
Transmitting, from a data network to a cellular network, information indicative of the cellular phone being communicatively coupled to said data network; and
Forwarding in response to said step of transmitting, calls directed to said cellular telephone from said cellular network to said data network.

2. The method of claim 1 wherein said converting occurs in a server connected to an IP network.

3. The method of claim 1 wherein said step of transmitting occurs using an out of band signaling network.

4. The method of claim 3 wherein said out of band signaling network in an SS7 or C7 telephone network.

5. The method of claim 1 wherein said step of transmitting occurs using the Internet.

6. The method of claim 1 wherein said transmitting also includes transmitting to said cellular telephone network information indicating that said network to which said cell phone is communicatively coupled is not a cellular network.

7. The method of claim 6 wherein said information also includes information indicating that said network to which said cellular telephone is communicatively coupled is an IP network.

8. A wireless apparatus capable of communicating directly with one of plural networks, said device comprising a processor for detecting a network interface and for automatically configuring said apparatus to communicate using either a packet switched data network or a cellular telephone network, depending upon which of plural types of networks are detected or which has higher priority using criteria selected by a user.

9. The wireless device of claim 8 wherein one of said plural types of networks is an IP network and wherein said apparatus interfaces to said IP network using a WiFi network.

10. The wireless device of claim 9 wherein said automatically configuring is accomplished in a prioritized order.

11. The wireless device of claim 10 wherein said prioritized order is programmable by a user.

12. A cellular telephony network comprising a switch/server for receiving signals from an IP network indicating that a cellular phone is roaming from its home network to the IP network, and means responsive to said signals indicating for configuring said wireless cellular telephony network to forward an incoming call directed to said roaming cellular telephone to said IP network.

13. A system including the cellular network of claim 12, connected to an IP server, said IP server including conversion data for converting an incoming telephone number into an IP address for completing said incoming call.

14. The system of claim 13 wherein said IP address is that of an adapter to which the cellular phone is connected or of the cellular phone, and wherein an access point completes the incoming call over a local area network (LAN) to said roaming cellular telephone or an adapter connected thereto.

15. The system of claim 14 wherein said LAN is either an Ethernet or a WiFi network.

16. The system of claim 14 wherein said roaming cellular telephone is inserted into an adapter, and wherein said adapter operates to change a protocol utilized by said roaming cellular telephone from that of a cellular telephone to that of a data networking device.

17. The system of claim 13 wherein the signals indicating roaming are transmitted out of band and wherein a media channel opened for conveyance of the incoming call is implemented in band.

18. A device for use in a cellular network comprising means for completing an incoming call to a wireless cell phone via the cellular network if the cell phone is not roaming and means for forwarding the incoming call to a packet switched data network if the cell phone is roaming to an area covered by an IP network.

19. The device of claim 18 wherein the packet switched data network is the Internet.

20. The device of claim 18 further including a switch/server to receive signals indicating whether the cell phone is roaming.

21. The device of claim 20 wherein the signals are received from the Internet.

22. The device of claim 20 wherein the signals are received using out of band signaling.

23. A method of communicating between two data devices, at least one of said data devices being a wireless device configured to be connected in a wireless manner to a packet switching network, the method comprising converting an IP address associated with said wireless device to a telephone number, transmitting the telephone number over a telephony network to an IP server connected to a data network, and, in response to said step of transmitting, forwarding packet switched data destined for said wireless device to said wireless device through said telephone network using the telephone number.

24. The method of claim 23 further comprising implementing a prestored priority protocol to determine the highest priority network available for use, and utilizing such highest priority network.

25. The method of claim 23 wherein at least one of said data devices is communicatively coupled to a WiFi network.

26. An adapter comprising an IP interface having an IP address, a telephone interface for connecting to a phone having a telephone number, and software for forwarding incoming data from an IP network to said telephone by converting said incoming IP signals to telephony signals such that said telephone receives an incoming telephone call.

27. The adaptor of claim 26 wherein said adapter is integrated within said telephone.

28. A communications network comprising a telephony network and a packet switching data network, a plurality of wireless data devices, a plurality of cell phones, a plurality of switches, and a plurality of servers, the communications network further comprising computers for determining if a cell phone or wireless data device is roaming, said wireless data devices and said cell phones being configurable to communicatively couple to said communications network using either the telephony network or the packet switching data network, depending at least upon whether said wireless devices or said cell phones are roaming, and to where said wireless devices and cell phones are roaming.

29. The communications network of claim 28 wherein if said computers determine that a cell phone or wireless data device is roaming, a home network associated with said device is signaled such that incoming calls and/or data sessions may be forwarded to a roaming network.

30. The communications network of claim 29 wherein the computers are implemented on the same hardware as the servers or switches.

31. The communications network of claim 29 wherein the home network is signaled via out of band signaling.

32. The communications network of claim 29 wherein said home network is signaled via a packet switched data network.

33. The communications network of claim 29 wherein at least some of the wireless data devices and the cell phones are configured to implement a prioritization system that causes communicative coupling between the communications network and the highest priority available network to couple thereto.

34. A first computer for directing a first server to send a telephone call to an access point over a data network, the computer comprising instructions to determine to which access point the call should be sent, communications means for transmitting an address of said access point for use by said first gateway, and an interface to instruct a switch/server to send the telephone call to the first gateway.

35. The first computer of claim 34 wherein said first computer includes functionality to act as a gatekeeper.

36. The first computer of claim 1 further comprising software to receive and process a signal from a network, which signal indicates that said cell phone has roamed onto an area within a purview of said data network.

37. The first computer of claim 36 further comprising instructions to determine a network access point from said signal received.

38. A system comprising a switch/server for interfacing to a cellular network, said switch/server comprising a first interface to receive from a first server information indicative of a cell phone associated with the cellular network having roamed onto a data network, and a second server connected to the data network, the switch server being configurable to forward calls arriving at the cellular network and destined for said cell phone to said second server.

39. The system of claim 38 wherein the switch server is so configured upon receipt of a message from said first server identifying said second server as a server to which said calls should be forwarded.

40. The system of claim 38 wherein said second server contacts said first server upon receipt of said forwarded call.

41. The system of claim 40 wherein said first server sends said second server information to forward said call to said cell phone.

42. The system of claim 41 wherein said first and second servers are one and the same.

43. A wireless device or cell phone comprising plural interfaces for interfacing to at least a cellular network or a data network, the wireless device including software for implementing a priority system that detects the presence of at least a cellular network and at least a data network, and communicatively couples the wireless device to a network having a highest priority.

44. The wireless device of claim 43, said wireless device being a cell phone.

45. A system including the wireless device of claim 43 communicatively coupled to a data network, said data network including a server, said server being configured to send out of band telephony signaling to a telephony network in response to a signal from said wireless device.

46. The system of claim 45 wherein said out of band telephony signaling is SS7 signaling.

47. The system of claim 46 wherein said SS7 signaling implements a transmission of an instant message.

48. The system of claim 46 wherein said SS7 signaling is utilized to advise a switch/server associated with a home cellular network that a cell phone associated with said home cellular network has roamed to an IP network.

49. A method of routing cellular telephone calls over an IP network, the method comprising: detecting, at the IP network, a cell phone associated with the cellular network; transmitting to the cellular network a message indicating that said cell phone is now communicatively coupled to said IP network; and receiving calls at the IP network that have been forwarded from the cellular network and which are destined for the IP cell phone.

50. The method of claim 49 wherein said detecting occurs when said cell phone is located in a prescribed area.

51. The method of claim 50 further comprising informing a home network associated with said cell phone to forward calls destined for said phone to the IP network.

52. The method of claim 51 wherein said informing is accomplished using out of band signaling.

53. A server for use in routing calls from a first cell phone having a first home network to a second phone, said server comprising a processor for accepting a call from said first cell phone destined for said second phone, routing said call over an IP network to which said server is connected if said second phone is within a purview of said IP network, and routing said call to said first home network for further routing if said second phone is not within a purview of said IP network.

54. The server of claim 53 wherein billing or authentication information is routed to said first home network regardless of whether said second cell phone is within said purview or not.

55. The server of claim 54 wherein said billing or authentication information is routed to said home network using out of band signaling.

56. A system comprising an IP phone and a cellular network, said IP phone including, or being connected to an adapter that includes, a processor for converting IP protocol packets conveyed to and from said IP phone to data suitable for receipt and processing by a cellular network, said cellular network being communicatively coupled to a home IP network associated with said IP phone.

57. The system of claim 56 wherein said cellular network communicates billing or authentication information back to the home IP network.

58. The system of claim 57 further including a server connected to said IP network to forward IP calls destined for said IP phone from said home IP network to said cellular network.

59. The system of claim 58 wherein said server and said cellular network communicate via an out of band telephony protocol.

60. The system of claim 13 further comprising conversion means for converting media information in the cellular network to IP format to facilitate communications with said IP network.

61. The system of claim 13 wherein said IP address is that of an access point on said IP network.

62. The system of claim 13 wherein the IP address is that of an intermediate router.

63. A storage medium having stored thereon instructions that, when executed by a computer, cause said computer or another computer to instruct a cellular telephone network to forward calls to a server on an IP network, and also cause said computer or another computer to instruct said server to where to route said call on said IP network.

64. The storage medium of claim 63 wherein said instructions cause said computer or another computer to instruct said server to where to route said call on said IP network after said call is routed to said server on said IP network.

65. The storage medium of claim 66 wherein said instructions also cause said computer or another computer to accept outgoing calls from a cell phone over a data network and forward such outgoing calls to a cellular network.

66. An adapter for a wireless device comprising a Personal Computer (PC), said PC being connected to a data network and being arranged to receive voice and data over said data network, and to distinguish between the two, said PC also including software and hardware to, upon recognition that arriving information is associated with voice, forward said arriving information over a wireless connection to a handheld wireless device.

67. The adapter of claim 66 wherein said handheld wireless device is a cordless phone.

68. The adapter of claim 66 wherein said handheld wireless device is a cell phone.

69. An adapter for use with a cellular phone comprising a protocol translator for translating between a cellular network protocol utilized by a cellular network and a PSTN protocol such that a cell phone inserted into said adapter can operate directly over the PSTN.

70. The adapter of claim 69 further comprising an additional protocol translator for translating between a protocol utilized by a cellular network and a protocol utilized by an IP network.

71. The adapter of claim 70 further comprising software for automatically selecting between plural network interfaces.
